(19) United States
(12) Patent Application Publication
(10) Pub. No.: US 2010/0058895 A1
(43) Pub. Date: Mar. 11, 2010

(54) Hose Clamp Pliers

(76) Inventor: Ming-Chieh Wu, Taichung City (TW)

Correspondence Address: Dr. BANGER SHIA, 102 Lindencrest Ct., Sugar Land, TX, 77479-5201, US

(21) Appl. No.: 12/208,321

(22) Filed: Sep. 10, 2008

(51) Int. Cl. B25B 27/10

(52) U.S. Cl. 81/9.3

(57) ABSTRACT

A pair of hose clamp pliers comprises a pair of universal pliers and two clamping plates. The pliers include two clamping ends capable of moving toward or away from each other. The two clamping plates are fixedly connected to the two clamping ends, and the respective clamping plates are formed with at least one opening. When in use, the two clamping plates are used to clamp the hose clamp, and the universal pliers are used to fix the positions of the two clamping ends, so that the user can position the hose clamp without exerting a continuous force.

### BACKGROUND OF THE INVENTION

1. Field of the Invention

The present invention relates to a pair of pliers, and more particularly to a pair of hose clamp pliers.

2. Description of the Prior Art

Conventionally, slim pipes, such as water hoses are often connected in such a way that the big-diameter pipe is forced onto the small-diameter pipe. For obtaining a tight connection between the two pipes, a hose clamp A, as shown in FIG. 1, is normally applied to improve the tightness of connection between the two pipes. The hose clamp A consists of an inner ring A1 and an outer ring A2. The inner ring A is an elongated sheet body which is bent into a ring in such a manner that two ends of the ring intersect with each other. One end of the inner ring A1 is formed with two first control protruding portions A11 having a clearance A12 therebetween. The other end of the inner ring A1 is formed with a second control protruding portion A13 accommodated in the clearance A12 between the two first control protruding portions A11. The outer ring A2 is formed by bending an elongated sheet body and mounted on the inner ring A1.

A pair of conventional hose clamp pliers, which is applicable to this kind of hose clamp A, is shown in FIG. 2 and comprises a pair of clamping pliers 10 and two clamping plates 20. The pair of clamping pliers 10 is made up of two pivoting arms 11 pivoted to each other. One end of the respective pivoting arms 11 is formed into a clamping end 111, and the other end of the respective pivoting arms 11 is formed into a handle portion 112. The two pivoting arms 11 are pivoted to each other through a pivot fastener 12. The position where the two pivoting arms 11 are pivoted to each other is located between the clamping end 111 and the handle portion 112 of the respective pivoting arms 11, so that the two pivoting arms 11 form an X-shape. The two clamping plates 20 are fixedly connected to the clamping ends 111 of the two pivoting arms 11 of the pair of clamping pliers 10, respectively. The opposite surfaces of the two clamping plates 20, as shown in FIG. 3, are each formed with plural openings 21 around the periphery thereof.

When in use, as shown in FIG. 4, the two first control protruding portions A11 of the inner ring A1 of the hose clamp A are disposed in two of the openings 21 of one of the clamping plates 20, respectively, the two clamping plates 20 clamps the two first control protruding portions A11 and the second control protruding portion A13 of the inner ring A1, and then the handle portions 112 of the two pivoting arms 11 are controlled to make the clamping ends 111 of the two pivoting arms 11 move toward each other to close the two clamping plates 20, as shown in FIG. 5, so that the distance between the respective first control protruding portions A11 and the second control protruding portion A13 is reduced to expand the inner diameter of the inner ring A1. In this case, the hose clamp A can be mounted on a pipe. After releasing the pliers, the outer ring A2 of the hose clamp A will fasten the inner ring A1 again, so that the distance between the respective control protruding portions A11 and the second control protruding portion A13 will be increased to reduce the inner diameter of the inner ring A1, thus fastening the hose clamp A on the pipe to improve the tightness of connection between two pressingly-engaged pipes.

However, during operation, the user has to exert a continuous force to grip the two handle portions 112 of the clamping pliers 10, thus demanding great effort. If the user fails to grip the handle portions 112 due to little attention, it is likely to make the hose clamp A elastically escape from the two clamping plates 20 abruptly, which may hurt the user.

The present invention has arisen to mitigate and/or obviate the afore-described disadvantages.

### SUMMARY OF THE INVENTION

The primary objective of the present invention is to provide a pair of hose clamp pliers, which utilizes two clamping plates fixed on two clamping ends of the pliers to clamp the hose clamp and fix the positions of the two clamping ends to allow the user to position the hose clamp without exerting a continuous force.

In order to achieve the above objective, the hose clamp pliers comprise a pair of universal pliers and two clamping plates. The universal pliers include a pivoting body, a clamping head, a control body, an adjustment rod and a spring. One end of the pivoting body is provided with a screw, and the other end of the pivoting body is pivoted to the clamping head. The pivoting body and the clamping head are each formed with a clamping end, and the two clamping ends of the pivoting body and the clamping head are opposite to each other. The clamping head is pivoted to one end of the control body, and the control body is pivoted to one end of the adjustment rod. The other end of the adjustment rod abuts against the screw of the pivoting body. Two ends of the screw are connected to the pivoting body and the clamping head, respectively. The two clamping plates are fixedly connected to the clamping heads of the pivoting body and the clamping head, respectively, and at least one of the clamping plates is formed in a periphery thereof with at least one opening having the same extending direction as the pivoting body.

When in use, the control body is controlled to pivot relative to the adjustment rod, and the control body synchronously moves the clamping head to pivot relative to the pivoting body, and then the clamping head will moves to extend or restore the spring, so that when the clamping head pivots relative to the pivoting body, the two clamping plates can be moved toward each other, and when the two clamping plates clamp the hose clamp, the universal pliers can fix the positions of the two clamping ends. Therefore, the user can position the hose clamp without exerting a continuous force.

### BRIEF DESCRIPTION OF THE DRAWINGS

FIG. 1 is a perspective view of a conventional hose clamp;

FIG. 2 is a perspective view of a conventional hose clamp pliers;

FIG. 3 is a perspective view illustrating clamping plates of the conventional hose clamp pliers;

FIG. 4 is a perspective view illustrating that the first control protruding portions are accommodated in the openings of the clamping plates of the conventional hose clamp pliers;

FIG. 5 is a schematic view illustrating that the hose clamp is clamped by the clamping plates of the conventional hose clamp pliers;

FIG. 6 is a perspective view of a pair of hose clamp pliers in accordance with the present invention;

FIG. 7 is a schematic view illustrating that one of the clamping plates is formed with an opening in accordance with the present invention;

FIG. 8 is a schematic view illustrating that one of the clamping plates is formed with two openings in accordance with the present invention; and

FIG. 9 is a schematic view illustrating that one of the clamping plates is formed with plural openings, and the other of the clamping plates is formed with zigzag structure in accordance with the present invention.

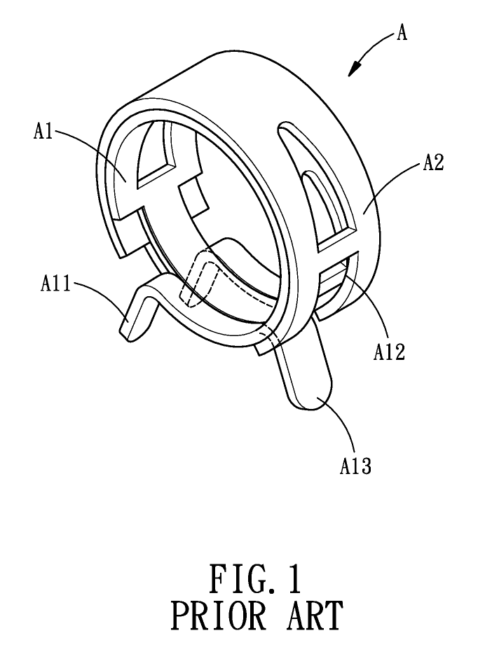

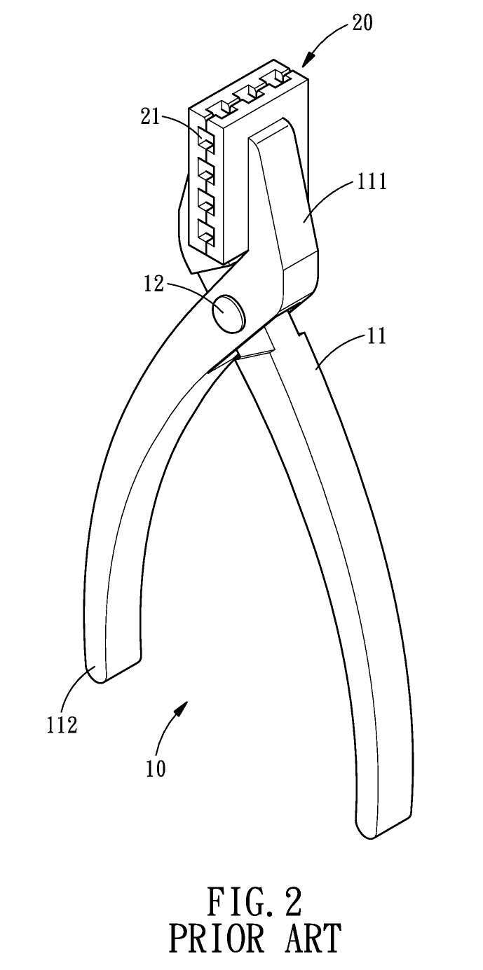

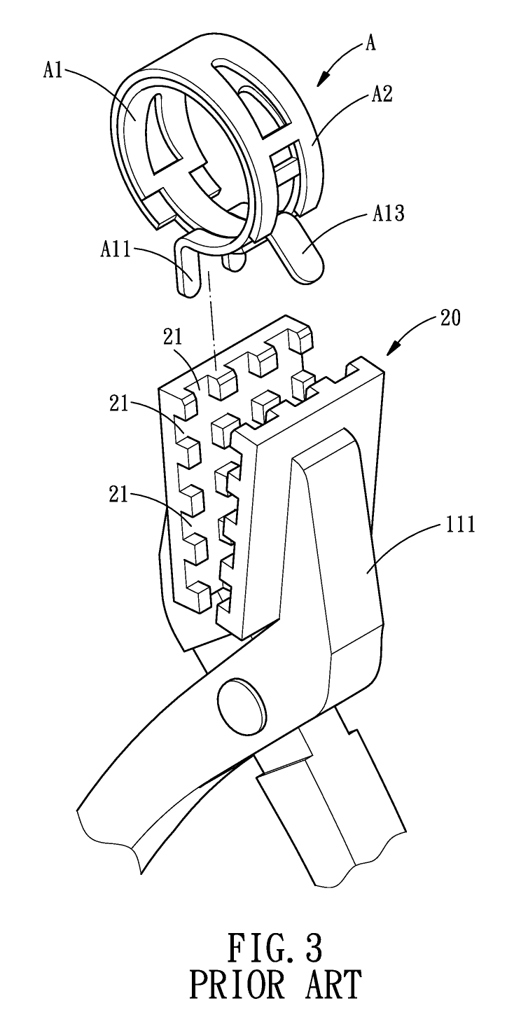

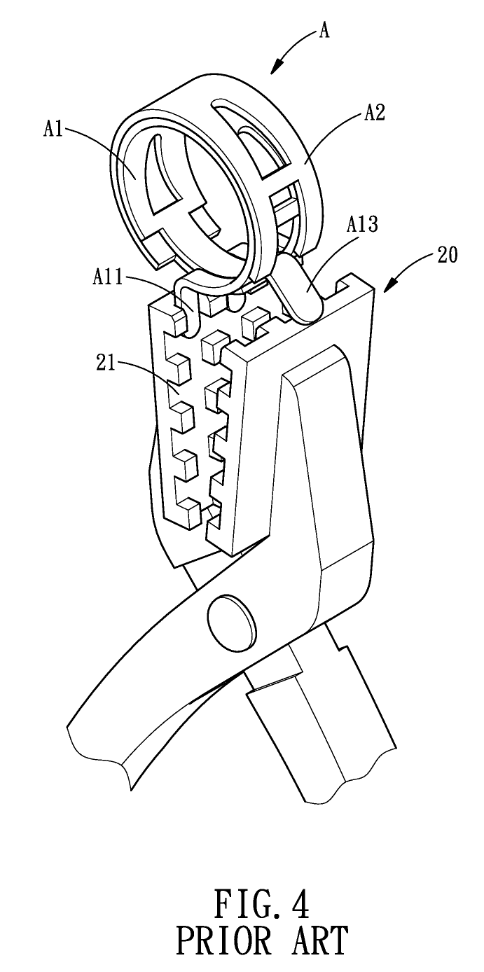

### DETAILED DESCRIPTION OF TIE PREFERRED EMBODIMENTS

The present invention will be clearer from the following description when viewed together with the accompanying drawings, which show, for purpose of illustrations only, the preferred embodiment in accordance with the present invention.

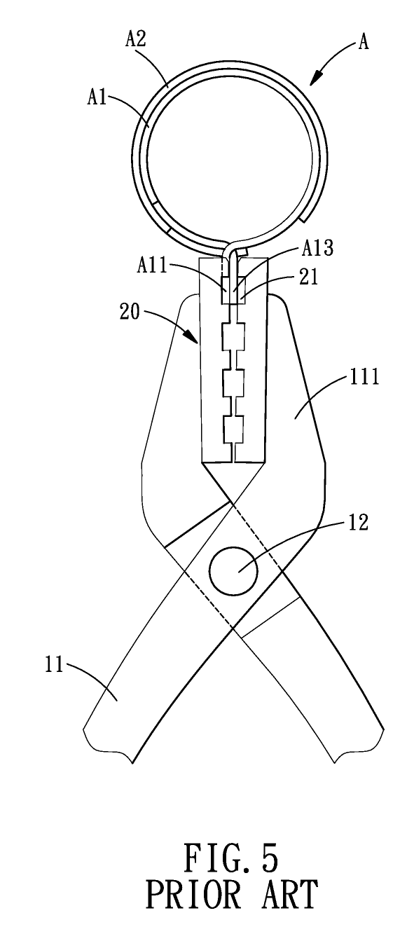

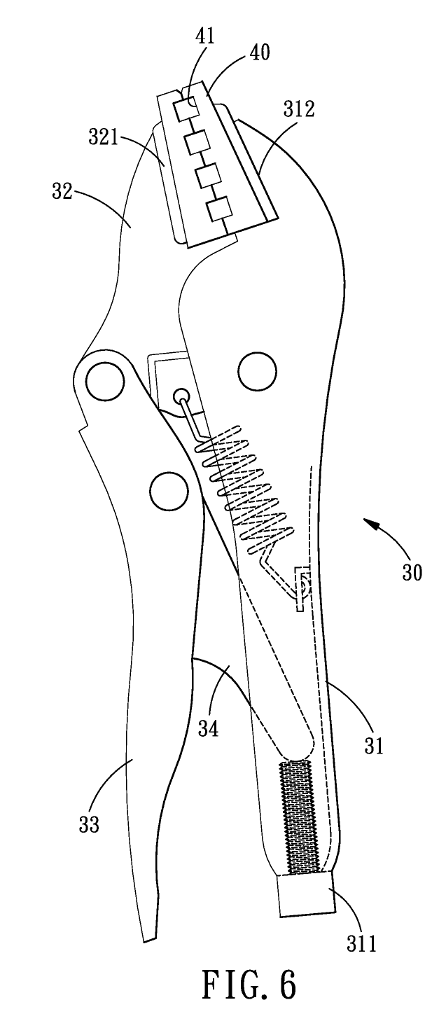

Referring to FIG. 6, a pair of hose clamp pliers in accordance with a preferred embodiment of the present invention comprises:

A pair of universal pliers 30 includes a pivoting body 31, a clamping head 32, a control body 33, an adjustment rod 34 and a spring 35. The pivoting body 31 has one end provided with a screw 311 and the other end pivoted to the clamping head 32. The pivoting body 31 and the clamping head 32 are each formed with a clamping end 312, 321, and the two clamping ends 312 and 321 are opposite to each other. The clamping head 32 is pivoted to one end of the control body 33, and the control body 33 is pivoted to one end of the adjustment rod 34. The other end of the adjustment rod 34 abuts against the screw 311 of the pivoting body 31. Two ends of the spring 35 are connected to the pivoting body 31 and the clamping head 32, respectively, so as to control the control body 33 to pivot relative to the adjustment rod 34. Meanwhile, the control body 33 drives the clamping head 32 to pivot relative to the pivoting body 31, and the clamping head 32 moves to extend or restore the spring 35, so as to fix the pivoting body 31 at a desired angle with respect to the clamping head 32 or keep the clamping head 30 open with respect to the pivoting body 31.

Two clamping plates 40 are respectively fixedly connected to the clamping ends 312, 321 of the clamping head 32 and the pivoting body 31 of the universal pliers 30 and located opposite each other. When the clamping head 32 pivots relative to the pivoting body 31, the relative position of the two clamping ends 312, 321 can be controlled to make the two clamping plates 40 approach each other to perform a clamping action. The opposite surfaces of the two clamping plates 40 are each formed with plural openings 41 around the periphery thereof, and at least one of the openings 41 has the same extending direction as the pivoting body 31.

When the hose clamp is clamped by the two clamping plates 40, the universal pliers 30 can be used to fix the clamping head 32 and the pivoting body 31 to make the two clamping ends 312, 321 keep clamping the hose clamp, so that the user can use the universal pliers 30 to position the hose clamp clamped by the two clamping plates 40 without exerting a continuous force.

Furthermore, adjusting the depth at which the screw 311 is screwed in the pivoting body 31 can drive the adjustment rod 34 to move, and then the adjustment rod 34 will move the control body 33 and the clamping head 32, so that the relative position of the clamping end 321 of the clamping head 32 and the clamping end 312 of the pivoting body 31 can be adjusted, thus controlling the distance between the clamping plates 40 fixed on the two clamping ends 312, 321 for adjusting the size of the clamped hose clamp.

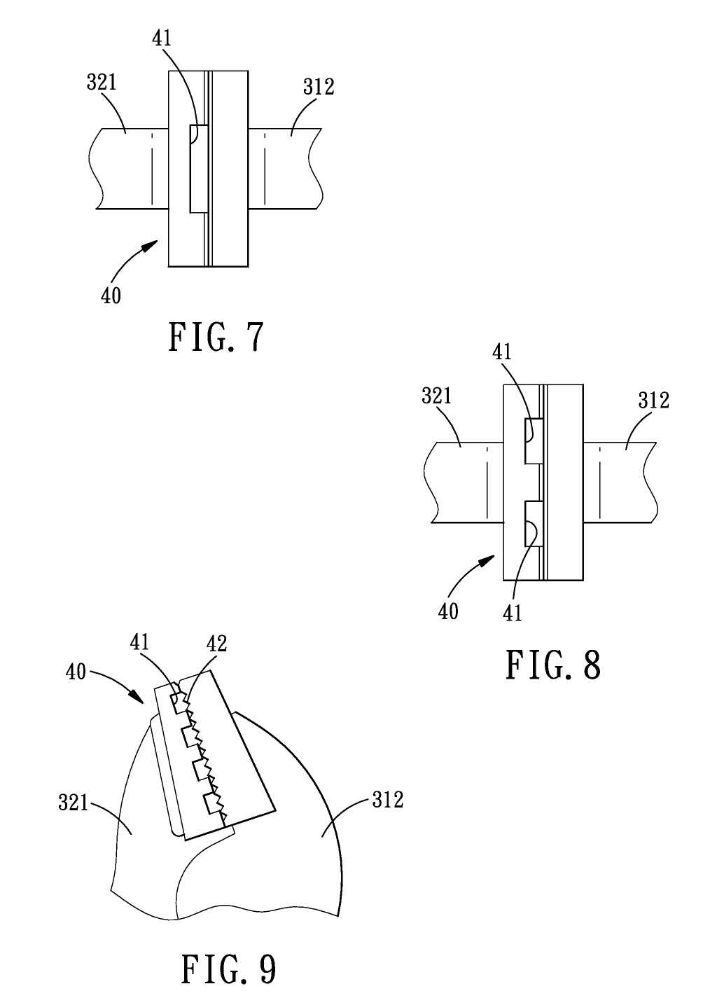

As for the number of the openings 41 of the two clamping plates 40, it can be such that only one of the clamping plates 40 is formed with an opening 41, as shown in FIG. 7, or two openings 41, as shown in FIG. 8, or as shown in 9, one of the clamping plates 40 is formed with plural openings 41, and the other of the clamping plates 40 is formed with a zigzag structure 42 on a surface opposite to the openings 41. These arrangements all can firmly clamp the hose clamp.

While we have shown and described various embodiments in accordance with the present invention, it is clear to those skilled in the art that further embodiments may be made without departing from the scope of the present invention.

What is claimed is:

1. A pair of hose clamp pliers, comprising:
a pair of universal pliers including a pivoting body, a clamping head, a control body, an adjustment rod and a spring, the pivoting body having one end provided with a screw and the other end pivoted to the clamping head, the pivoting body and the clamping head being each formed with a clamping end, and the two clamping ends being opposite to each other, the clamping head being pivoted to one end of the control body, and the control body being pivoted to one end of the adjustment rod, the other end of the adjustment rod abutting against the screw of the pivoting body, two ends of the spring being connected to the pivoting body and the clamping head, respectively; and
two clamping plates being respectively fixedly connected to the clamping ends of the clamping head and the pivoting body of the universal pliers and located opposite to each other, at least one of the two clamping plates being formed in a periphery thereof with at least one opening having the same extending direction of the pivoting body.

2. The pair of hose clamp pliers as claimed in claim 1, wherein one of the two clamping plates is formed with two openings.

3. The pair of hose clamp pliers as claimed in claim 1, wherein one of the two clamping plates is formed with plural openings.

4. The pair of hose clamp pliers as claimed in claim 3, wherein the two clamping plates each are formed with plural openings.

5. The pair of hose clamp pliers as claimed in claim 3, wherein one of the two clamping plates is formed with plural openings, and the other of the two clamping plates is formed with a zigzag structure opposite to the plural openings.
